(19) United States
(12) Patent Application Publication
(10) Pub. No.: US 2025/0341321 A1
(43) Pub. Date: Nov. 6, 2025

(54) DEHUMIDIFYING DEVICE AND METHOD WITH VAPOR PRESSURE DEFICIT CONTROL

(71) Applicant: AC Infinity Inc., City of Industry, CA (US)

(72) Inventors: Jimmy Liu, Brea, CA (US); Daniel Yu Hsu, Upland, CA (US); Wilbur Y. Cheng, Chino Hills, CA (US); Wei Ying Shao, Alhambra, CA (US)

(21) Appl. No.: 18/653,780

(22) Filed: May 2, 2024

(51) Int. Cl. F24F 3/14; A01G 9/24; F24F 11/30; F24F 110/12; F24F 110/22

(52) U.S. Cl. CPC F24F 3/14; A01G 9/246; F24F 11/30; F24F 2003/144; F24F 2110/12; F24F 2110/22

(57) ABSTRACT

A dehumidifying device with VPD control for indoor residential cannabis cultivation. The dehumidifying device with VPD control includes: a control module with a processing unit, a display screen and an IO interface; a dehumidifier for providing dry air in response to a dehumidifier control signal from the control module; a fan for circulating dry air in response to a fan control signal from the control module; and a temperature-humidity sensor for sensing an environmental temperature value T_{ENV} and an environmental relative humidity value RH within an indoor cannabis cultivation environment, the environmental temperature value T_{ENV} and the environmental relative humidity value RH_{ENV} are transmitted to the control module in real time, and a leaf VPD value VPD_{LEAF} is calculated from the environmental temperature value T_{ENV} and the environmental relative humidity value RH_{ENV} by the processing unit of the control module.

### FIELD OF INVENTION

This invention relates to vapor pressure deficiency control device and method for indoor plant cultivation, and in particular to vapor pressure deficiency control device and method for residential indoor cannabis cultivation to increase cannabis yields.

### BACKGROUND OF INVENTION

Commercial indoor plant growers use temperature and humidity parameters to fine tune their cultivation environment to increase plant yield, but for emerging residential indoor growers, they often lack the tools needed to maintain an optimal growing environment with temperature and humidity. Such tools include for example, humidifier, dehumidifier, air conditioner, and heater.

An object of the invention is to provide an improved and efficient device and method to control the residential indoor cannabis cultivation environment using vapor pressure deficiency (“VPD” hereafter.) By utilizing VPD, residential growers can eliminate at least one or two of the above-mentioned expensive equipment's while still maintaining the same optimal cultivation environment as long as the temperature and humidity of the cultivation space does not reach extreme levels. This is because both the heater and the dehumidifier are able to increase VPD, while both the air conditioner and humidifier are able to decrease VPD.

### SUMMARY OF INVENTION

Vapor Pressure Deficit, or VPD, plays a crucial role in plant indoor cultivation, especially high valued plants, such as cannabis. VPD is the difference between moisture that is currently in the air and how much moisture the air can hold at saturation, or dew point under certain conditions.

According to an embodiment of the invention, a dehumidifying device with VPD control for indoor residential cannabis cultivation is disclosed. The dehumidifying device with VPD control includes: a control module with a processing unit, a display screen and an IO interface; a dehumidifier for providing dry air in response to a dehumidifier control signal from the control module; a fan for circulating dry air in response to a fan control signal from the control module; and a temperature-humidity sensor for sensing an environmental temperature value T_{ENV} and an environmental relative humidity value RH within an indoor cannabis cultivation environment, the environmental temperature value T_{ENV} and the environmental relative humidity value RH_{ENV} are transmitted to the control module in real time, and a leaf VPD value VPD_{LEAF} is calculated from the environmental temperature value T_{ENV} and the environmental relative humidity value RH_{ENV} by the processing unit of the control module.

According to an embodiment of the invention, the leaf VPD value VPD_{LEAF} is compared with a pre-determined VPD threshold value VPD_{θ} to determine running modes of the dehumidifier and the fan to control the leaf VPD value VPD_{LEAF} within the indoor cannabis cultivation environment, and the control module transmits the dehumidifier control signal to the dehumidifier to adjust the environmental temperature value T_{ENV} and the environmental relative humidity value RH_{ENV} within the indoor cannabis cultivation environment.

According to an embodiment of the invention, the temperature-humidity sensor senses an updated environmental temperature value T_{ENV} and an updated environmental relative humidity value RH_{ENV} within the indoor cannabis cultivation environment; the updated environmental temperature value T_{ENV} and the updated environmental relative humidity value RH_{ENV} are transmitted to the control module; and an updated leaf VPD value VPD_{LEAF} is calculated from the updated environmental temperature value T_{ENV} and the updated environmental relative humidity value RH_{ENV} by the processing unit of the control module.

According to an embodiment of the invention, the updated leaf VPD value VPD_{LEAF} is compared with the pre-determined VPD threshold value VPD_{θ} again to adjust the running modes of the dehumidifier to control the leaf VPD within the indoor cannabis cultivation environment; and the control module transmits the dehumidifier control signal to the dehumidifier to adjust the environmental temperature value T_{ENV} and the environmental relative humidity value RH_{ENV} within the indoor cannabis cultivation environment.

According to an embodiment of the invention, a dehumidifying device with VPD control for indoor residential cannabis cultivation is disclosed. The dehumidifying device with VPD control includes: a power unit for providing electric power to the dehumidifying device with VPD control for indoor residential cannabis cultivation; a fan driven by a motor; a dehumidifier for providing dry air to the dehumidifying device with VPD control for indoor residential cannabis cultivation, wherein the dehumidifier includes a plurality of dehumidifying power gears under a dehumidifying mode; an IO interface for input and output of control information and status information; a temperature-humidity sensor for sensing an environmental temperature value T_{ENV} and an environmental relative humidity value RH_{ENV} within an indoor cannabis cultivation environment, wherein a leaf VPD value VPD_{LEAF} is calculated from the environmental temperature value T_{ENV} and the environmental relative humidity value RH_{ENV}; and a main control unit for communicating with and controlling the power unit, the fan, the motor, the dehumidifier, the IO interface, and the temperature-humidity sensor, wherein, in a VPD dehumidifying mode of the dehumidifying device with VPD control, the leaf VPD value VPD_{LEAF} calculated from the environmental temperature value T_{ENV} and the environmental relative humidity value RH_{ENV} is implemented to control the dehumidifying device with VPD control for indoor residential cannabis cultivation.

According to an embodiment of the invention, the leaf VDP is calculated from the environmental temperature value T_{ENV} and the environmental relative humidity value RH_{ENV} by:

$$Leaf VPD = 610.78 {e}^{17.2694 \frac{{T}_{E N V} + Leaf Offset}{237.3 + {T}_{E N V} + Leaf Offset}} - 61 \; 0.78 {e}^{17 \text{.2694} \frac{{T}_{ENV}}{237.3 + {T}_{E N V}}} \times \frac{R {H}_{E N V}}{100} ,$$

wherein, Leaf Offset is the difference between the leaf temperature and the environment temperature, wherein VPD unit is in Pa, T_{ENV} is temperature of the air in degrees Celsius, RH_{ENV} is relative humidity of air in % unit and e≈2.71828.

According to an embodiment of the invention, when the Leaf Offset is defaulted to 0° C., the leaf VPD value is calculated from the environmental temperature value T_{ENV} and the environmental relative humidity value RH_{ENV} via:

$$Leaf VPD = 610.78 {e}^{17.2694 \frac{{T}_{E N V}}{237.3 + {T}_{E N V}}} ( 1 - \frac{R {H}_{E N V}}{100} ) ,$$

wherein, Leaf VPD unit is in Pa, T_{ENV} is temperature of the air in degrees Celsius, RH_{ENV} is relative humidity of air in % unit and e≈2.71828.

According to an embodiment of the invention, the user can set a Leaf Offset value between-10° C. and 10° C. According to an embodiment of the invention, in a VPD dehumidification mode, when the leaf VPD is smaller than or equal to a predetermined threshold VPDs, the dehumidifying power gear is increased gradually to a Max-level dehumidifying power gear set in the ON dehumidification mode, wherein when the leaf VPD is greater than the predetermined threshold VPDs, the dehumidifying power gear is decreased gradually to a Min-level dehumidifying power gear set in the OFF dehumidification mode. According to an embodiment of the invention, in an AUTO dehumidification mode, a humidity threshold value Hs is set between 0 and 100 using the IO interface, when the environmental humidity value H_{ENV} is greater than or equal to the humidity threshold value Hs, the dehumidifying power gear is increased gradually to the Max-level dehumidifying power gear set in the ON dehumidifying mode, when the environmental humidity value H_{ENV} is smaller than the humidity threshold value Hs, the dehumidifying power gear is decreased gradually to the Min-level dehumidifying power gear set in the OFF dehumidifying mode. According to an embodiment of the invention, in a TIMER dehumidification mode, a countdown timer is set using the IO interface, wherein when the countdown time is not zero, the Max-level dehumidifying power gear is run, wherein when the countdown time reaches zero, the Min-level dehumidifying power gear is run. According to an embodiment of the invention, in a CYCLE dehumidification mode, an ON-time is set, and an OFF-time is set using the IO interface, wherein during the ON-time, the Max-level dehumidifying power gear is run, wherein during the OFF-time, the Min-level dehumidifying power gear is run.

According to an embodiment of the invention, a dehumidifying device with VPD control for an indoor residential cannabis cultivation environment is disclosed. The dehumidifying device includes: a top cover of the enclosure, a front cover of the enclosure, a rear cover of the enclosure, and a bottom of the enclosure; an air entry opening and an air exit opening implemented on opposing sides of the enclosure; a control panel with a display screen mounted on the front cover of the enclosure; a control module integrated into the control panel with a user IO interface for input and output of control information; a water tank slidably implemented in the lower part of the enclosure; a water level buoy located inside the water tank, wherein the water level buoy is electronically connected to the control module for providing water level information signal; a dehumidifying unit implemented between the air entry opening and the air exit opening, wherein the dehumidifying unit is implemented for providing dry air in response to a dehumidifier control signal from the control module; a fan implemented between the air entry opening and the dehumidifying unit, wherein the fan is implemented for driving air into the air entry opening through the dehumidifying unit, and driving air out of the air exit opening into the indoor residential cannabis cultivation environment in response to a fan control signal from the control module; and a temperature-humidity sensor outside the enclosure for sensing an environmental temperature value T_{ENV} and an environmental relative humidity value RH_{ENV} within the indoor cannabis cultivation environment.

According to an embodiment of the invention, the environmental temperature value T_{ENV} and the environmental relative humidity value RH_{ENV} are transmitted to the control module in real time, and a leaf VPD value VPD_{LEAF} is calculated from the environmental temperature value T_{ENV} and the environmental relative humidity value RH_{ENV} by the processing unit of the control module. According to an embodiment of the invention, the dehumidifying device with VPD control for an indoor residential cannabis cultivation environment further includes: a hose connected to the air exit opening for transiting dry air generated by the dehumidifying device into the indoor residential cannabis cultivation environment, wherein the hose is connected to the air exit opening via a connector. According to an embodiment of the invention, the dehumidifying device with VPD control for an indoor residential cannabis cultivation environment further includes: a second hose connected to the air entry opening for drawing air to the dehumidifying unit from the indoor residential cannabis cultivation environment, wherein the second hose is connected to the air entry opening via a connector. According to an embodiment of the invention, the dehumidifying device with VPD control for an indoor residential cannabis cultivation environment further includes: a USB-C connector mounted on the rear cover of the enclosure for connecting an external controller to the control module in the enclosure for additional controls. According to an embodiment of the invention, the dehumidifying device with VPD control for an indoor residential cannabis cultivation environment further includes: an audio headphone jack mounted on the rear cover of the enclosure for connecting to the temperature-humidity sensor outside the enclosure.

According to an embodiment of the invention, the dehumidifying unit is controlled by comparing the leaf VPD value VPD_{LEAF} with a predetermined threshold VPD value VPDs to optimize cannabis cultivation in the indoor residential cannabis cultivation environment. According to an embodiment of the invention, the dehumidifying device with VPD control for an indoor residential cannabis cultivation environment further includes: a filter between the hose and the air exit opening and a second filter between the second hose and the air entry opening ensure air quality passed into the dehumidifying unit.

### BRIEF DESCRIPTION OF THE FIGURES

The invention will now be explained in more detail using exemplary embodiments and with references to the drawings, in which:

FIG. 1 is an exploded view of the VPD dehumidifier, according to an embodiment of the invention.

FIG. 2 is another view of the VPD dehumidifier, according to an embodiment of the invention.

FIG. 3 is another view of the VPD dehumidifier, according to an embodiment of the invention.

FIG. 4 is another view of the VPD dehumidifier, according to an embodiment of the invention.

FIG. 5 is another view of the VPD dehumidifier, according to an embodiment of the invention.

FIG. 6 is a chart illustrating the relationship among VPD, temperature and relative humidity in cannabis cultivation, according to an embodiment of the invention.

FIG. 7 is a functional flowchart of the equipment error warning messages of the VPD dehumidifier, according to an embodiment of the invention.

FIG. 8 is functional flowchart of the VPD dehumidifier in dehumidifying mode, according to an embodiment of the invention.

### DETAILED DESCRIPTION OF PREFERRED EMBODIMENTS

The invention is susceptible of many embodiments. Preferred embodiments are illustrated in the attached figures and explained below. Minor variations of the preferred embodiments are evident in the figures, but are substantially the same, with common or similar components and the same reference numbers, except as noted.

The saturation vapor pressure deficit of an air sample (sometimes “vapor pressure deficit, VPD” or just “saturation deficit” for short) is the difference between the saturation vapor pressure and the actual vapor pressure at temperature T, i.e., SVP (Saturation Vapor Pressure)−AVP (Actual Vapor Pressure). VPD is the difference between moisture that is currently in the air and how much moisture the air can hold at saturation, or dew point under certain conditions. In ecological problems, VPD is often regarded as a measure of the “drying power” of air, because it plays an important part in determining the relative rates of growth and transpiration in plants. In micrometeorology, the vertical gradient of saturation deficit is a measure of the lack of equilibrium between a wet surface and the air passing over it. Vapor Pressure Deficit (“VPD”) plays a crucial role in plant indoor cultivation, especially high valued plants, such as cannabis.

The environment VPD can be calculated from environmental temperature value T_{ENV} and the environmental relative humidity value RH_{ENV}. By definition, VPD=SVP (Saturation Vapor Pressure)−AVP (Actual Vapor Pressure), SVP is the “Saturation Vapor Pressure” and AVP is the “Actual Vapor Pressure”.

$$S V P = 610.78 {e}^{17.2694 \frac{{T}_{E N V}}{237.3 + {T}_{E N V}}} ,$$

wherein, 610.78, 17.2694 and 237.3 are constants, and T_{ENV} is temperature of the environment in degrees Celsius.

$$A V P = 6 10.78 {e}^{17.2694 \frac{{T}_{E N V}}{237.3 + {T}_{E N V}}} \frac{R {H}_{E N V}}{100} ,$$

wherein, RH_{ENV} is the relative humidity of environment in % unit, and 610.78, 17.2694 and 237.3 are constants, T_{ENV} is temperature of the environment in degrees Celsius.

$$Environment VPD = S V P - A V P = 6 10.78 {e}^{17.2694 \frac{{T}_{E N V}}{237.3 + {T}_{E N V}}} ( 1 - \frac{R {H}_{E N V}}{100} ) ,$$

wherein, VPD_{ENV} unit is in Pa, T_{ENV} is temperature of the environment in degrees Celsius. RH_{ENV} is the relative humidity of environment in % unit, e≈2.71828.

The SVP value can be calculated by, for example, the following code:

```
/************************VPD***************************/
double get_svp (double t)
{
  double svp, power;
  power = t / (t + 237.3) * 17.2694;
  svp = 610.78 * pow (2.71828, power);
  return svp;
}
```

The code shows the calculation of the saturated vapor pressure SVP (Saturation Vapor Pressure) from a temperature of the air T. The unit is Pa. On the display, it is possible to display either Pa or kPa, or other units if appropriate.

According to another embodiment of the invention, the VPD can be calculated by following the steps below:
a. Obtaining real time environment temperature value T_{ENV} (° C.) and real time environmental relative humidity value RH_{ENV}, set the Leaf Offset value;
b. Calculating the leaf temperature T_{LEAF}=T_{ENV}+Leaf Offset, wherein T_{ENV} (C) is real time environment temperature, T_{LEAF} (° C.) is leaf temperature, Leaf Offset is the difference between the leaf and the environment temperature, Leaf Offset=T_{LEAF}−T_{ENV};

c. Calculating ASVP, which is the environment SVP, wherein

$$ASVP = 610.78 {e}^{17.2694 \frac{{T}_{E N V}}{237.3 + {T}_{E N V}}} ;$$

d. Calculating LSVP, which is the leaf SVP, wherein

$$LSVP = 6 10.78 {e}^{17.2694 \frac{{T}_{LEAF}}{237.3 + {T}_{LEAF}}} ;$$

e. Calculating leaf VPD, wherein Leaf VPD value VPD_{LEAF}=LSVP−(ASVP×RH/100);
f. Calculating real time Leaf VPD, wherein

$$Leaf VPD value {VPD}_{L E A F} = LSVP - ASVP \times RH / 100 = 610.78 {e}^{17.2694 \frac{{T}_{LEAF}}{237.3 + {T}_{LEAF}}} - 610.78 {e}^{17.2694 \frac{{T}_{E N V}}{237.3 + {T}_{E N V}}} \times \frac{R {H}_{E N V}}{100} ,$$

wherein the unit of Leaf VPD value VPD_{LEAF} is Pa, the unit of temperature is ° C., the unit of RH is %, and e≈2.71828.

The default value of Leaf Offset is 0, which means that T_{ENV}=T_{LEAF}, and the default value of the leaf VPD is equal to environment VPD, i.e., under the default condition

$$Leaf VPD = 610.78 {e}^{17.2694 \frac{{T}_{E N V}}{237.3 + {T}_{E N V}}} ( 1 - \frac{R {H}_{E N V}}{100} ) .$$

VPD plays an important role in cannabis cultivation. Plants respond to changes in water availability in both their aerial and soil environments. The driving force of transpiration rate is the gradient in vapour pressure between the dry atmosphere and the wet interior of leaves, which is referred to as VPD as discussed above.

A high VPD indicates a hotter and drier environment, while a low VPD results from a cooler and more humid environment. Scientific studies have demonstrated that the cannabis is highly responsive to changes in VPD, and VPD has been identified as a critical factor influencing transpiration and stomatal conductance in crops including cannabis.

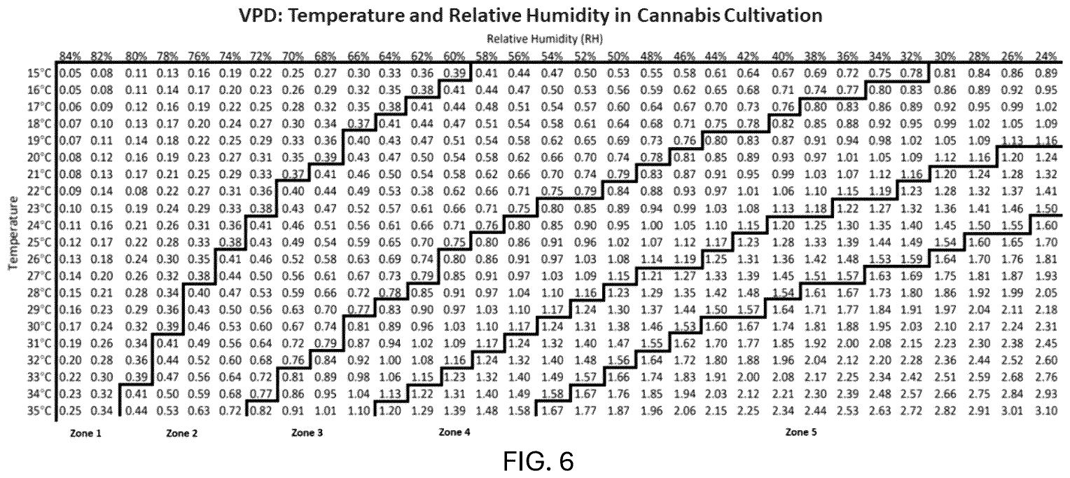

For cannabis growers with indoor grow tents or rooms with artificial lighting, in addition to temperature and relative humidity parameters, it is critical to take into consideration the importance of VPD and its impact on transpiration or nutrient uptake. For example, as illustrated in FIG. 6, in the chart depicting the relationship between temperature, humidity and VPD below, there are five zones: zone 1 through zone 5, with different combinations of temperature and relative humidity values. For example, zone 1: danger zone; zone 2: blue zone for low transpiration stage, propagation stage and early vegetative stage; zone 3: green zone for optimized healthy growth during transpiration stage, late vegetative state, and early flower stage; zone 4: yellow zone for high transpiration stage and late flower stage; zone 5: danger zone. Among these zones, zone 3 is the optimal zone with ideal combinations of temperature and relative humidity value for cannabis plants. For different stages, such as growth and flowering stages, temperature, relative humidity, and the recommended leaf VPD values are listed in the chart in FIG. 6.

Different VPD values are recommended for different stages of the plant. For example, for VPD value between 1.20 kPa and 1.60 kPa, which is considered relatively high, plants tend to open their stomata and release a considerable amount of water vapour into the environment to increase their transpiration. This increase in transpiration results in an increase in the plant's photosynthetic activity and will improve its overall growth during both growth and bloom. The optimal VPD range is between 0.80 kPa and 1.20 kPa. When the VPD is too high, the plant closes its stomata to avoid releasing excessive amount of the water vapor into the environment. Excessive transpiration causes dehydration. On the other hand, when VPD is too low, the atmosphere is already saturated and has reached the maximum water retention capacity, the plant will also close its stomata to avoid releasing too much water vapor into the atmosphere. Decreased transpiration reduces photosynthesis, slowing the plant's development and lowering yield.

There are two types of VPD's: air VPD (or environment VPD VPD_{ENV}) and leaf VPD VPD_{LEAF}. Leaf VPD value VPD_{LEAF} is what is been calculated in the present invention, which assumes that a leaf surface temperature is the same as the air temperature. This may not, however, always be the case due to external factors, such as light shining on a leaf causing it to heat up. According to the embodiment of the invention, there is an option in the dehumidifier settings to allow users to measure and input the leaf surface temperature in relation to the air temperature (leaf offset), which will change the VPD_{ENV} reading to an estimated leaf VPD value VPD_{LEAF} reading.

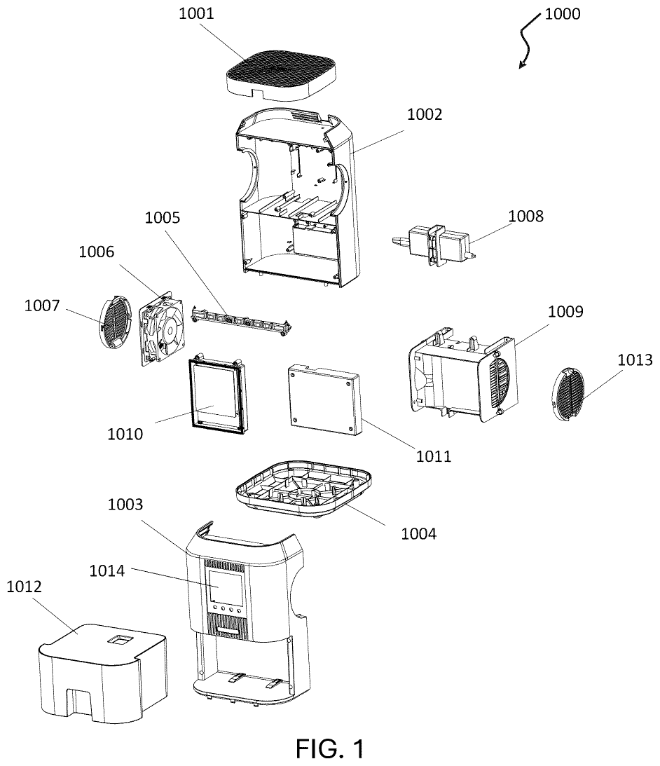

FIG. 1 is an exploded view of the VPD dehumidifier, according to an embodiment of the invention. The VPD dehumidifier 1000, or the dehumidifying device with VPD control 1000 is with VPD control, which includes a top cover 1001, a front cover 1003, a back cover 1002 and a bottom cover 1004. On the enclosure, specifically on the left and right side of the enclosure, two openings are implemented for air entry into and exit out of the enclosure, of which, one opening is an air entry unit 1007, and the other is an air exit unit 1013. The are entry and air exit units 1007 and 1013 are preferably implemented on the opposing sides of the enclosure. Next the air entry unit 1007, a fan module 1006 is implemented to draw air in the environment into the air entry unit 1007, then into the dehumidifying unit 1009, or the dehumidifier 1009, implemented next to it for dehumidification. The dehumidifying unit 1009 is implemented next to the air exit unit 1013, the dehumidified air leaves the VPD dehumidifier 1000 from the air exit 1013. A sealing component 1005 is implemented to seal the enclosure and corresponding covers and components. On the front cover 1003, there is a display screen 1014 for displaying control information, the display screen 1014 can be a regular LCD screen, with buttons for information input. The display screen 1014 can also be a touch screen, which also functions as an input device. Behind the display screen 1014 and inside the enclosure, there is a control board 1010, which contains control circuitry for controlling the display and functioning of the display screen 1014. The control board 1010 contains the main control unit for the entire dehumidifying device with VPD control. The control board 1010 contains a processing unit, which can be any general-purpose computer chips, CPUs, special purpose chips, or other equivalent control circuitry. The control board 1010 can also control other electronic components of the VPD dehumidifier 1000, for example, the fan 1006, the dehumidifying unit 1009, etc. The VPD dehumidifier 1000 includes a power unit 1008 for providing power to all electronic components of the VPD dehumidifier 1000, including the control board 1010, the fan 1006, the display screen 1014, and the dehumidifying unit 1009. Behind the control board 1010, there is a connector and socket unit for connecting the control board and all other electronic components of the VPD dehumidifier 1000. A water tank 1012 with matching size and shape is implemented close to the bottom of the VPD dehumidifier 1000 to collect water coming out of the dehumidifying unit 1009. When the water tank is full, a warning message will be displayed on the display screen 1014.

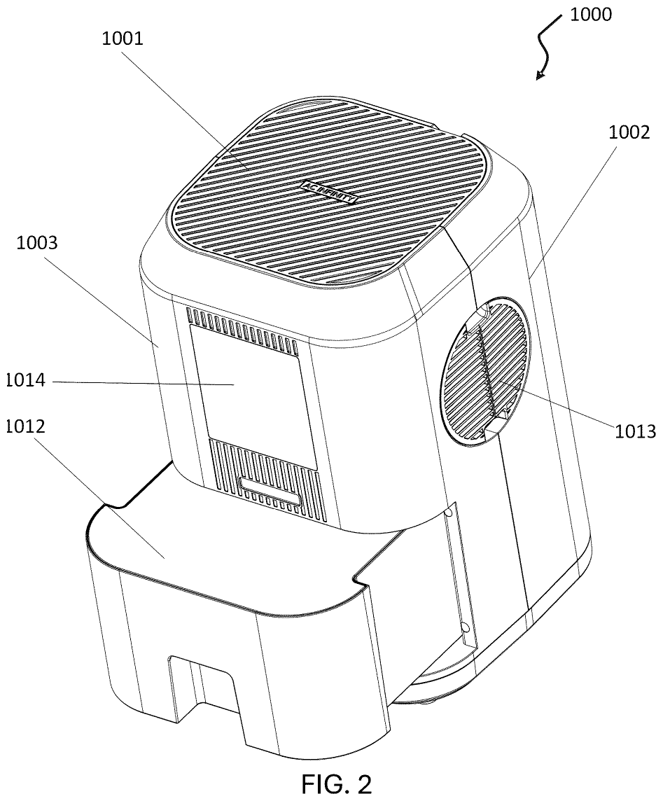

FIG. 2 is another view of the VPD dehumidifier, according to an embodiment of the invention. FIG. 2 illustrates a perspective view of the VPD dehumidifier 1000 when all components in FIG. 1 are properly assembled together. As illustrated, louvers can be implemented outside the air exit 1013 for properly directing the air flow. Also as illustrated, the water tank 1012 can be slide in and out of the bottom of the VPD dehumidifier 1000 like a drawer. When water is full in the water tank 1012, it can be slide out and emptied.

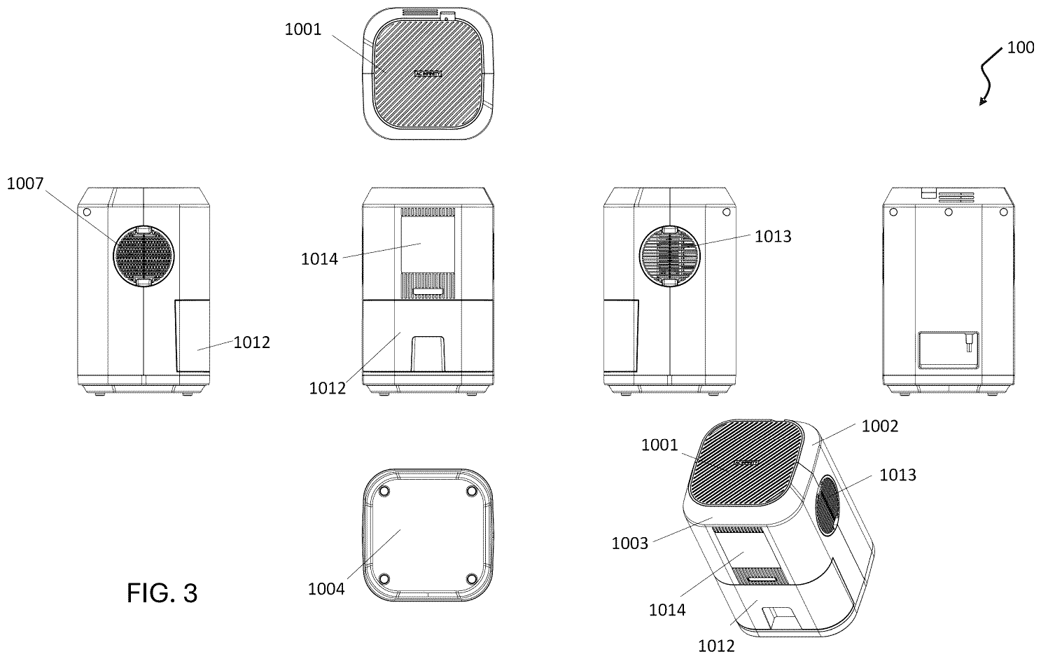

FIG. 3 is another view of the VPD dehumidifier, according to an embodiment of the invention. FIG. 3 illustrates a front view, rear view, left view, right view, top view, bottom view, and a perspective view of the VPD dehumidifier 1000. As illustrated, the air entry unit 1007 and the air exit unit 1013 are implemented on the opposing sides of the enclosure, at matching heights. The water tank 1012 occupies one third to half of the bottom height of the enclosure.

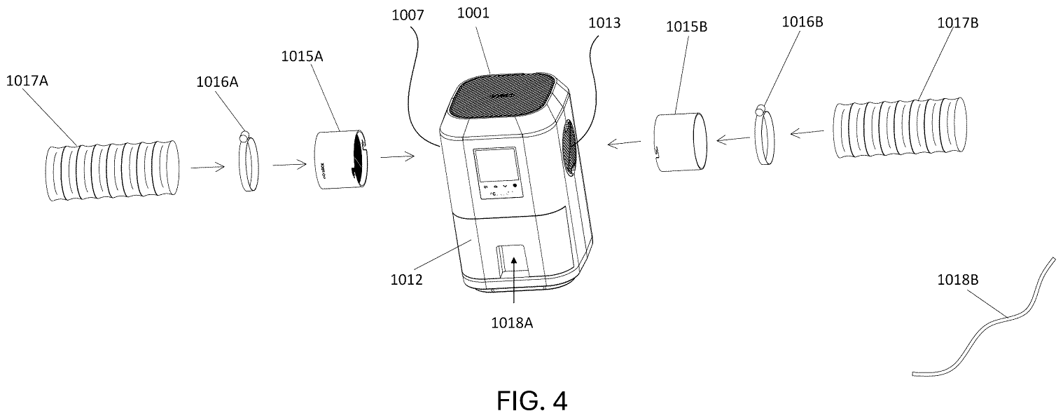

FIG. 4 is another view of the VPD dehumidifier, according to an embodiment of the invention. FIG. 4 illustrates the external components of the VPD dehumidifier 1000, including hoses, hose clamps and filter pipes. For example, on the air entry side 1007, a filter pipe 1015A is directly connected to the air entry unit 1007, then an air entry hose 1017A is connected to the filter pipe 1015A and tightened by a hose clamp 1016A. Similarly on the air exit side 1013, a filter pipe 1015B is directly connected to the air exit unit 1013, then an air exit hose 1017B is connected to the filter pipe 1015B and tightened by a hose clamp 1016B. A water pipe 1018B is additionally implemented to direct water flow. According to an embodiment of the invention, a tube-insert 1018A is plugged to the water tank 1012. This tube-insert has a plastic plug to prevent it from leaking and if the customer wants to automatically drain the water tank, they can remove the plastic plug and attach on the water pipe 1018B which will direct the drained water away from the dehumidifier.

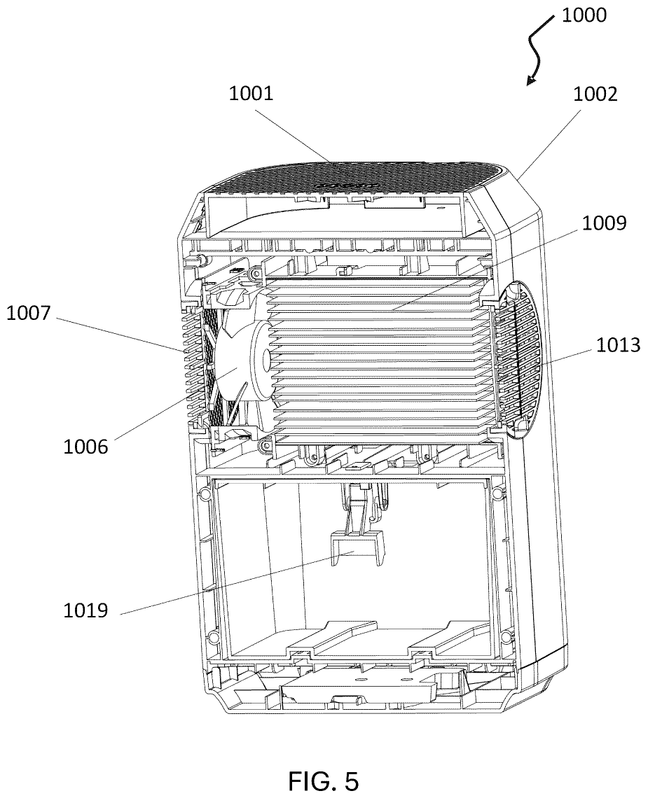

FIG. 5 is sectional view of the VPD dehumidifier, according to an embodiment of the invention. As illustrated, humid air flow is drawn into the VPD dehumidifier by the fan 1006 from the air entry unit 1007 and passed through the dehumidifying unit 1009 to obtain dehumidified air, which is then pushed out of the enclosure through the air exit unit 1013. As illustrated, inside the water tanks, there is a water level buoy 1019 which, in response to the water level inside the water tank 1012, transmits a water level signal, or a water level warning signal to the control board 1010 of the VPD dehumidifier 1000. At a predetermined high water-level, a water tank full warning signal is produced and displayed on the display screen 1014 on the front cover 1003 of the VPD dehumidifier 1000 enclosure.

FIG. 6 is a chart illustrating the relationship among VPD, temperature and relative humidity in cannabis cultivation, according to an embodiment of the invention. For cannabis growers with indoor grow tents or rooms with artificial lighting, in addition to temperature and relative humidity parameters, it is critical to take into consideration the importance of VPD and its impact on transpiration or nutrient uptake. For example, as illustrated in FIG. 6, in the chart depicting the relationship between temperature, humidity and VPD below, there are five zones: zone 1 through zone 5, with different combinations of temperature and relative humidity values. For example, zone 1: danger zone; zone 2: blue zone for low transpiration stage, propagation stage and early vegetative stage; zone 3: green zone for optimized healthy growth during transpiration stage, late vegetative state, and early flower stage; zone 4: yellow zone for high transpiration stage and late flower stage; zone 5: danger zone. Among these zones, zone 3 is the optimal zone with ideal combinations of temperature and relative humidity value for cannabis plants. For different stages, such as growth and flowering stages, temperature, relative humidity, and the recommended leaf VPD values are listed in the chart in FIG. 6.

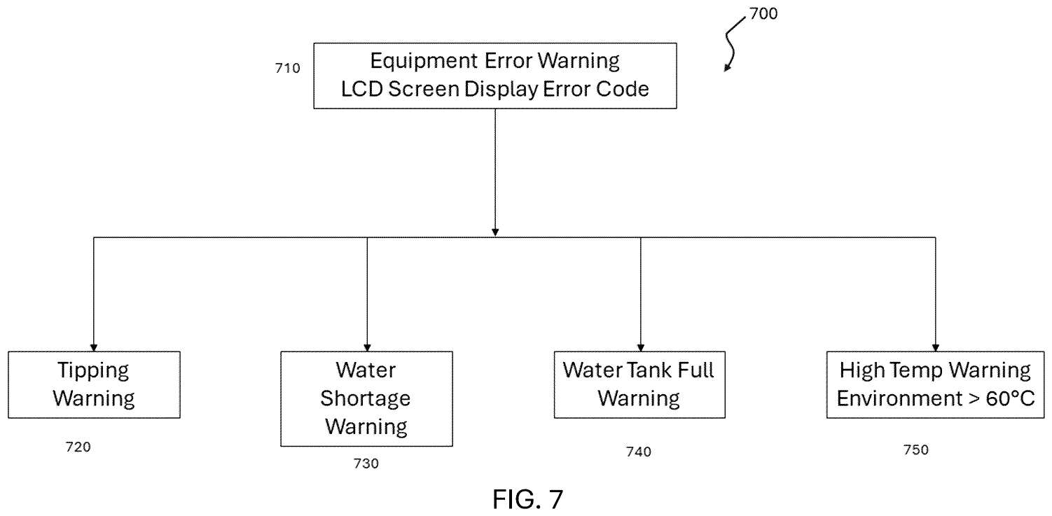

FIG. 7 is a functional flowchart of the equipment error warning messages of the VPD dehumidifier, according to an embodiment of the invention. FIG. 7 is a flowchart of the equipment error warnings of a dehumidifying device with VPD control, or VPD dehumidifier, according to an embodiment of the invention. The equipment error warning mechanism 700 includes at least four warning codes, the equipment error warning 710 is caused by, for example, warning code 720 is a tipping warning, warning code 730 is water shortage warning, and warning code 740 is water tank full warning, warning code 750 is high temperature warning. When any one of the errors happens, the error is reported to the equipment error warning mechanism 710, which displays the corresponding error message(s) on the LCD screen on the front cover.

There are 10 power gear levels for the dehumidifier: gear-0 through gear-10. For each power gear level, there is a corresponding fan power gear level: gear-0 through gear-10. Under the dehumidifying mode, the dehumidifier is at full power, i.e., 64 W, except gear-0, which is OW. For each fan power gear level, there is a corresponding fan speed. The dehumidifier device dehumidifying mode power gears, corresponding fan power gears, and fan speed are detailed in the table below:

Dehumidifying Mode: Dehumidifier Full Power, Fan Gear 0-10

| Dehumidifier | Dehumidifier | | |
|---|---|---|---|
| Gear | Power (W) | Fan Gear | Fan Speed (RPM) |
| Gear-0 | 0 | Gear-0 | 0 |
| Gear-1 | 64 | Gear-1 | 1000 |
| Gear-2 | 64 | Gear-2 | 1450 |
| Gear-3 | 64 | Gear-3 | 1850 |
| Gear-4 | 64 | Gear-4 | 2300 |
| Gear-5 | 64 | Gear-5 | 2750 |
| Gear-6 | 64 | Gear-6 | 3200 |
| Gear-7 | 64 | Gear-7 | 3650 |
| Gear-8 | 64 | Gear-8 | 4100 |
| Gear-9 | 64 | Gear-9 | 4550 |
| Gear-10 | 64 | Gear-10 | 5000 |

In the fan mode, the dehumidifier power is at gear-0. For each fan power gear, gear-0 through gear-10, there is a corresponding fan speed. The dehumidifier device fan mode power gears and fan speed are detailed in the table below:

Fan Mode: Dehumidifier Off, Fan Gear 0-10

| Fan Gear | Fan Speed (RPM) | Dehumidifier Power |
|---|---|---|
| Gear-0 | 0 | Gear-0 |
| Gear-1 | 1000 | Gear-0 |
| Gear-2 | 1450 | Gear-0 |
| Gear-3 | 1850 | Gear-0 |
| Gear-4 | 2300 | Gear-0 |
| Gear-5 | 2750 | Gear-0 |
| Gear-6 | 3200 | Gear-0 |
| Gear-7 | 3650 | Gear-0 |
| Gear-8 | 4100 | Gear-0 |
| Gear-9 | 4550 | Gear-0 |
| Gear-10 | 5000 | Gear-0 |

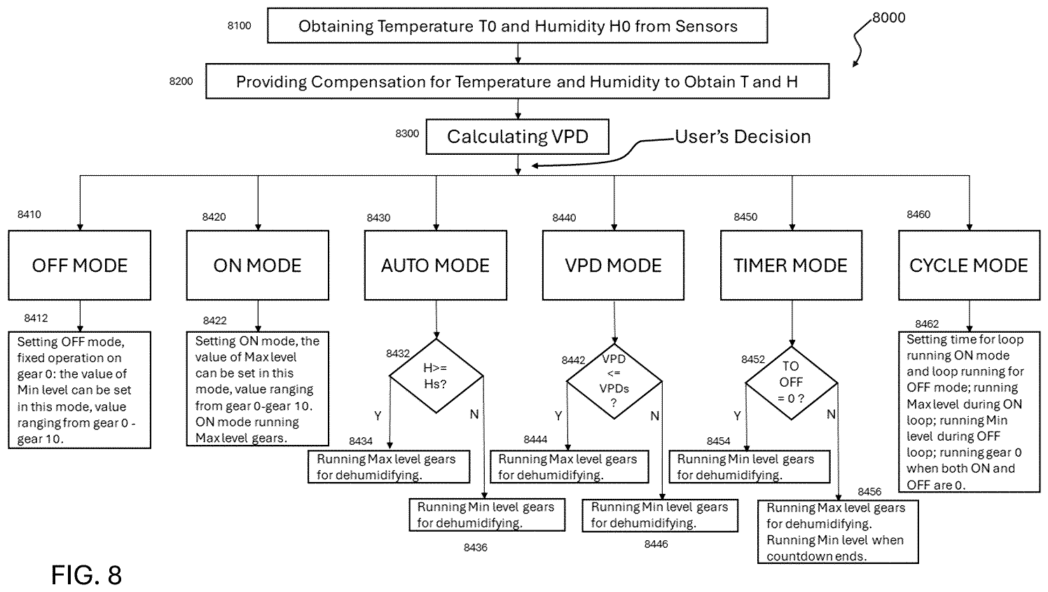

FIG. 8 is flowchart of the VPD control method in dehumidifying mode, according to an embodiment of the invention. The VPD control method 8000 includes a first step 8100, obtaining a temperature T₀ and a humidity H₀ from sensors. According to the embodiments discussed above, temperature sensors and humidity sensor are deployed inside the indoor growing tent or room with artificial lighting. These temperature sensors and humidity sensors are connected to the control unit in which the temperature and humidity values are received and used to calculate VPD. The second step 8200 is: providing compensation for temperature and humidity to obtain temperature T and relative humidity RH. Then at the third step 8300, calculating VPD using T and RH values. A decision is made to determine which mode to run selected from a plurality of dehumidifying modes, or dehumidification modes.

According to an embodiment of the invention, there are, for example, six dehumidifying modes: OFF mode, ON mode, AUTO mode, VPD mode, TIMER mode and CYCLE mode. Throughout the entirety of this application, dehumidifying mode carry the same meaning as dehumidification mode. Accordingly, the six dehumidifying modes can also be called: OFF dehumidification mode, ON dehumidification mode, AUTO dehumidification mode, VPD dehumidification mode, TIMER dehumidification mode and CYCLE dehumidification mode.

The first mode 8410 is OFF mode, in which the step 8412 is performed: setting OFF mode, default dehumidifying setting is gear-0, the device is not running. The value of Min level dehumidifying power can be set in this mode, value ranging from gear-0 to gear-10. Min level dehumidifying power is the customized minimum dehumidifying power level in a dehumidifying mode.

The second mode 8420 is ON mode, in which the step 8422 is performed: setting ON mode, the default dehumidifying gear is 6. The value of Max level dehumidifying power can be set in this mode, value ranging from gear 0 to gear 10. ON mode runs the Max level dehumidifying power gear. Max level dehumidifying power is the customized maximum dehumidifying power level in a dehumidifying mode.

The third mode 8430 is AUTO mode, the default setting is OFF, in which humidity His compared to a predetermined humidity value Hs at step 8432. Humidity can be set and changed cyclically from 0 to 100 by pressing the INCREASE/DECREASE buttons. When a predetermined humidity value Hs is set, if the humidity reading H from the sensor is lower than predetermined humidity value, step 8436 is performed, OFF mode is trigged, and the dehumidifying gear gradually decreases to the Min level dehumidifying power under OFF mode. On the other hand, if the humidity reading H from the sensor is higher than or equal to the predetermined value Hs, step 8434 is performed, ON mode is triggered, and the dehumidifying gear increases gradually to the Max level dehumidifying power under ON mode.

The fourth mode is VPD mode 8440, in which VPD is compared to a predetermined VPDₛ. VPD value can be set and changed cyclically from 0.0 kPa to 3.0 kPa by pressing the INCREASE/DECRESE buttons. After setting the VPDₛ value, the VDP value calculated from the sensor readings is compared to the predetermined VPDₛ. If VPD is smaller than or equal to VPDₛ, step 8444 is performed: ON mode is triggered and dehumidifying gear is gradually increased to the Max level dehumidifying power under ON mode. Otherwise, if VPD>VPDₛ, step 8446 is performed: OFF mode is triggered, and the dehumidifying gear decreases gradually to the Min level dehumidifying power under OFF mode.

The fifth mode is TIMER mode 8450, in which a TIMER is set and tracked, when the TIMER is not zero, perform step 8456: running Max level dehumidifying power gear; when TIMER reaches 0, perform step 8454: running Min level dehumidifying power gear; if TIMER is set to 0, continue to run Min level dehumidifying power. The TIMER default value is 0:00.

The last mode 8460 is CYCLE mode, in which step 8462 is performed: setting ON-time for loop running ON mode and OFF-time for loop running for OFF mode; running Max level dehumidifying power during ON loop; running Min level dehumidifying power during OFF loop; running gear 0 when both ON-time and OFF-time are 0. The default ON-time and OFF-time are both 0:00. According to an embodiment of the invention, the user can choose gear-2 as the minimum level gear, and gear-7 as the maximum level gear. In AUTO mode, the dehumidifier runs gear-7 for dehumidifying when the humidity is detected to be higher than the set humidity, and gear-2 for dehumidifying when it is lower than the predetermined humidity threshold. Similarly, in VPD mode, TIMER mode and Cycle mode, the dehumidifier can run gear-2 and gear-7 as Min level dehumidifying power and Max level dehumidifying power correspondingly as well.

According to an embodiment of the invention, there are four fan modes: ON mode, OFF mode, TIMER mode, and CYCLE mode, which can also be called ON fan mode, OFF fan mode, TIMER fan mode, and CYCLE fan mode. In ON mode, the fan runs the maximum fan speed. In OFF mode, the fan runs minimum fan speed. In TIMER mode, the fan runs maximum speed when the TIMER is not zero and runs minimum fan speed when the TIMER reaches zero. In CYCLE mode, the fan runs maximum fan speed during ON time and minimum fan speed in OFF time.

Overall, the dehumidifying device with VPD control, is powered by a 12V DC input power supply, LDO step-down output 5V, 3.3V to power the entire system. The LDO step-down output 10V supplies power to the external controller through the interface board. The buzzer is controlled by the main control chip. The RTC clock circuit provides the countdown time to the main control chip. Anti-tipping switch circuit sends a signal to the main control chip when the product tips over. And the dehumidifying device with VPD control also includes CAN circuit and TYPE-C jack interface, which can be connected to an external proprietary control box produced by the inventor's company to control its products. The dehumidifying device with VPD control includes CAN function to enable its software to be upgraded. The dehumidifying device with VPD control includes temperature and humidity sensors to obtain temperature and humidity information in the environment. The temperature and humidity information are sent to the main control chip for further processing and control. The NTC sensors are implemented to detect radiator temperature. The water level sensor detects the water level in the water tank through the water level buoy. The fan driver drives the fan in response to control signal from the main control chip.

When the power of the VPD dehumidifier is turned on, the system starts functioning. The main controller, or the microcontroller, is initiated, the LCD back light is turned on, and the LCD screen is turned on. After initiation, temperature and humidity sensors data are read displayed on the LCD screen. The buzzer buzzes when the keys are touched, and the LCD screen displays corresponding work mode or power mode, working conditions and warning status, if any. At the same time, the fan starts running to draw air into the cold end of the semiconductor refrigeration chip and condense into water droplets, and the heat at the hot end of the semiconductor refrigeration chip is discharged. Touch buttons, or touch keys can be pressed to set the dehumidification power gear levels, and the main control chip sends the corresponding PWM control signal to the fan to control its dehumidification power gear level.

The dehumidifying device with VPD control as discussed above is a specialty device which has not previously been invented specifically for indoor cannabis cultivation, no dehumidifier or similar dehumidifier with controller as discussed above is on the market as of the day of the filing of this patent application. There exists long-felt market need. The dehumidifying device with VPD control as discussed above requires unconventional sensor choices, specialty programming, and modifications to a dehumidifier's design to allow it to be integrated into a residential indoor cannabis cultivation space. This long-felt specialty market need is not fulfilled so far by any other designs on the market.

The dehumidifying device with VPD control as discussed above requires a redesign of the conventional dehumidifier to accept not only the humidity sensor readings, but in addition, it requires it to be able to compute these humidity sensor readings along with the temperature sensor readings to provide an air VPD value. The dehumidifier needs to be reprogrammed to be controllable based on the VPD readings instead of just temperature, which is completely novel to the indoor cannabis cultivation dehumidifier market. The hardware, firmware, and software all need to be redesigned and redeveloped to accomplish the dehumidifying device with VPD control as discussed above, which can also be called a VPD dehumidifier for indoor cannabis cultivation, or a dehumidifying device with VPD control for indoor cannabis cultivation. The present invention includes several additional unique hardware features added to this specific VPD dehumidifier, such as the external sensors, expandable tubing, and air intake fan controls, etc., which are all specifically developed to cater to the indoor residential cannabis cultivation market.

Controlling the environment via VPD that only caters to a specific consumer market, such as the indoor residential cannabis cultivation market, is relatively new. The high cost of setting up an indoor residential cannabis cultivation room or tent has long prevented the market from developing any specialty devices until recently, with the introduction of legalized residential indoor cannabis cultivation across the nation. When combined with the high cost of legally purchasing cannabis, this has led to the rise of consumers looking to start their own residential indoor cannabis cultivation. Financially, with each plant grown having a market value of on average $200-$1000, residential growers are now willing to spend much more on specialty indoor grow devices to improve their plant quality as they can often recapture the cost of expensive indoor cultivation equipment within 3-6 months. This has led to a push for better indoor cultivation equipment to be developed.

Other and various embodiments within the scope of the invention will be readily evident to practitioners skilled in the art, from specification, figures and claims that follow.

What is claimed is:

1. A dehumidifying device with VPD control for indoor residential cannabis cultivation, the dehumidifying device with VPD control comprising:
a control module with a processing unit, a display screen and an IO interface;
a dehumidifier for providing dry air in response to a dehumidifier control signal from the control module;
a fan for circulating dry air in response to a fan control signal from the control module; and
a temperature-humidity sensor for sensing an environmental temperature value T_{ENV} and an environmental relative humidity value RH within an indoor cannabis cultivation environment,
wherein the environmental temperature value T_{ENV} and the environmental relative humidity value RH_{ENV} are transmitted to the control module in real time, and
wherein a leaf VPD value VPD_{LEAF} is calculated from the environmental temperature value T_{ENV} and the environmental relative humidity value RH_{ENV} by the processing unit of the control module.

2. The dehumidifying device with VPD control for indoor residential cannabis cultivation of claim 1,
wherein the leaf VPD value VPD_{LEAF} is compared with a pre-determined VPD threshold value VPD_{θ} to determine running modes of the dehumidifier and the fan to control the leaf VPD value VPD_{LEAF} within the indoor cannabis cultivation environment, and
wherein the control module transmits the dehumidifier control signal to the dehumidifier to adjust the environmental temperature value T_{ENV} and the environmental relative humidity value RH_{ENV} within the indoor cannabis cultivation environment.

3. The dehumidifying device with VPD control for indoor residential cannabis cultivation of claim 2,
wherein the temperature-humidity sensor senses an updated environmental temperature value T_{ENV} and an updated environmental relative humidity value RH_{ENV} within the indoor cannabis cultivation environment;
wherein the updated environmental temperature value T_{ENV} and the updated environmental relative humidity value RH_{ENV} are transmitted to the control module; and
wherein an updated leaf VPD value VPD_{LEAF} is calculated from the updated environmental temperature value T_{ENV} and the updated environmental relative humidity value RH_{ENV} by the processing unit of the control module.

4. The dehumidifying device with VPD control for indoor residential cannabis cultivation of claim 3,
wherein the updated leaf VPD value VPD_{LEAF} is compared with the pre-determined VPD threshold value VPD_{θ} again to adjust the running modes of the dehumidifier to control the leaf VPD within the indoor cannabis cultivation environment; and
wherein the control module transmits the dehumidifier control signal to the dehumidifier to adjust the environmental temperature value T_{ENV} and the environmental relative humidity value RH_{ENV} within the indoor cannabis cultivation environment.

5. A dehumidifying device with VPD control for indoor residential cannabis cultivation, the dehumidifying device with VPD control comprising:
a power unit for providing electric power to the dehumidifying device with VPD control for indoor residential cannabis cultivation;
a fan driven by a motor;
a dehumidifier for providing dry air to the dehumidifying device with VPD control for indoor residential cannabis cultivation, wherein the dehumidifier includes a plurality of dehumidifying power gears under a dehumidifying mode;
an IO interface for input and output of control information and status information;
a temperature-humidity sensor for sensing an environmental temperature value T_{ENV} and an environmental relative humidity value RH_{ENV} within an indoor cannabis cultivation environment, wherein a leaf VPD value VPD_{LEAF} is calculated from the environmental temperature value T_{ENV} and the environmental relative humidity value RH_{ENV}; and
a main control unit for communicating with and controlling the power unit, the fan, the motor, the dehumidifier, the IO interface, and the temperature-humidity sensor, wherein, in a VPD dehumidifying mode of the dehumidifying device with VPD control, the leaf VPD value VPD_{LEAF} calculated from the environmental temperature value T_{ENV} and the environmental relative humidity value RH_{ENV} is implemented to control the dehumidifying device with VPD control for indoor residential cannabis cultivation.

6. The dehumidifying device with VPD control for indoor residential cannabis cultivation of claim 5, wherein the leaf VDP is calculated from the environmental temperature value T_{ENV} and the environmental relative humidity value RH_{ENV} by:
$$Leaf VPD = 610.78 {e}^{17.2694 \frac{{T}_{E N V} + Leaf Offset}{2373 + {T}_{E N V} + Leaf Offset}} - 610 \text{.78} {e}^{17.2694 \frac{{T}_{E N V}}{237.3 + {T}_{E N V}}} \times \frac{R {H}_{E N V}}{100} ,$$
wherein, Leaf Offset is the difference between the leaf temperature and the environment temperature, wherein VPD unit is in Pa, T_{ENV} is temperature of the air in degrees Celsius, RH_{ENV} is relative humidity of air in % unit and e≈2.71828.

7. The dehumidifying device with VPD control for indoor residential cannabis cultivation of claim 6, wherein when the Leaf Offset is defaulted to 0° C., the leaf VPD value is calculated from the environmental temperature value T_{ENV} and the environmental relative humidity value RH_{ENV} via:
$$Leaf VPD = 6 10.78 {e}^{17.2694 \frac{{T}_{E N V}}{237.3 + {T}_{E N V}}} ( 1 - \frac{R {H}_{E N V}}{100} ) ,$$
wherein, Leaf VPD unit is in Pa, T_{ENV} is temperature of the air in degrees Celsius, RH_{ENV} is relative humidity of air in % unit and e≈2.71828.

8. The dehumidifying device with VPD control for indoor residential cannabis cultivation of claim 6, wherein the user can set a Leaf Offset value between −10° C. and 10° C.

9. The dehumidifying device with VPD control for indoor residential cannabis cultivation of claim 7, wherein in a VPD dehumidification mode, when the leaf VPD is smaller than or equal to a predetermined threshold VPDs, the dehumidifying power gear is increased gradually to a Max-level dehumidifying power gear set in the ON dehumidification mode, wherein when the leaf VPD is greater than the predetermined threshold VPDs, the dehumidifying power gear is decreased gradually to a Min-level dehumidifying power gear set in the OFF dehumidification mode.

10. The dehumidifying device with VPD control for indoor residential cannabis cultivation of claim 7, wherein in an AUTO dehumidification mode, a humidity threshold value Hs is set between 0 and 100 using the IO interface, when the environmental humidity value H_{ENV} is greater than or equal to the humidity threshold value Hs, the dehumidifying power gear is increased gradually to the Max-level dehumidifying power gear set in the ON dehumidifying mode, when the environmental humidity value H_{ENV} is smaller than the humidity threshold value Hs, the dehumidifying power gear is decreased gradually to the Min-level dehumidifying power gear set in the OFF dehumidifying mode.

11. The dehumidifying device with VPD control for indoor residential cannabis cultivation of claim 7, wherein in a TIMER dehumidification mode, a countdown timer is set using the IO interface, wherein when the countdown time is not zero, the Max-level dehumidifying power gear is run, wherein when the countdown time reaches zero, the Min-level dehumidifying power gear is run.

12. The dehumidifying device with VPD control for indoor residential cannabis cultivation of claim 7, wherein in a CYCLE dehumidification mode, an ON-time is set, and an OFF-time is set using the IO interface, wherein during the ON-time, the Max-level dehumidifying power gear is run, wherein during the OFF-time, the Min-level dehumidifying power gear is run.

13. A dehumidifying device with VPD control for an indoor residential cannabis cultivation environment, the dehumidifying device comprising:
a top cover of the enclosure, a front cover of the enclosure, a rear cover of the enclosure, and a bottom of the enclosure;
an air entry opening and an air exit opening implemented on opposing sides of the enclosure;
a control panel with a display screen mounted on the front cover of the enclosure;
a control module integrated into the control panel with a user IO interface for input and output of control information;
a water tank slidably implemented in the lower part of the enclosure;
a water level buoy located inside the water tank, wherein the water level buoy is electronically connected to the control module for providing water level information signal;
a dehumidifying unit implemented between the air entry opening and the air exit opening, wherein the dehumidifying unit is implemented for providing dry air in response to a dehumidifier control signal from the control module;
a fan implemented between the air entry opening and the dehumidifying unit, wherein the fan is implemented for driving air into the air entry opening through the dehumidifying unit, and driving air out of the air exit opening into the indoor residential cannabis cultivation environment in response to a fan control signal from the control module; and
a temperature-humidity sensor outside the enclosure for sensing an environmental temperature value T_{ENV} and an environmental relative humidity value RH_{ENV} within the indoor cannabis cultivation environment.

14. The dehumidifying device with VPD control for an indoor residential cannabis cultivation environment of claim 13,
wherein the environmental temperature value T_{ENV} and the environmental relative humidity value RH_{ENV} are transmitted to the control module in real time, and
wherein a leaf VPD value VPD_{LEAF} is calculated from the environmental temperature value T_{ENV} and the environmental relative humidity value RH_{ENV} by the processing unit of the control module.

15. The dehumidifying device with VPD control for an indoor residential cannabis cultivation environment of claim 13, further comprises:
a hose connected to the air exit opening for transiting dry air generated by the dehumidifying device into the indoor residential cannabis cultivation environment, wherein the hose is connected to the air exit opening via a connector.

16. The dehumidifying device with VPD control for an indoor residential cannabis cultivation environment of claim 15, further comprises:
a second hose connected to the air entry opening for drawing air to the dehumidifying unit from the indoor residential cannabis cultivation environment, wherein the second hose is connected to the air entry opening via a connector.

17. The dehumidifying device with VPD control for an indoor residential cannabis cultivation environment of claim 13, further comprises:
a USB-C connector mounted on the rear cover of the enclosure for connecting an external controller to the control module in the enclosure for additional controls.

18. The dehumidifying device with VPD control for an indoor residential cannabis cultivation environment of claim 13, further comprises:
an audio headphone jack mounted on the rear cover of the enclosure for connecting to the temperature-humidity sensor outside the enclosure.

19. The dehumidifying device with VPD control for an indoor residential cannabis cultivation environment of claim 13, wherein the dehumidifying unit is controlled by comparing the leaf VPD value VPD_{LEAF} with a predetermined threshold VPD value VPDs to optimize cannabis cultivation in the indoor residential cannabis cultivation environment.

20. The dehumidifying device with VPD control for an indoor residential cannabis cultivation environment of claim 16, further comprises: a filter between the hose and the air exit opening and a second filter between the second hose and the air entry opening ensure air quality passed into the dehumidifying unit.
